(19) United States
(12) Patent Application Publication
(10) Pub. No.: US 2022/0238959 A1
(43) Pub. Date: Jul. 28, 2022

(54) FUNCTIONAL COATING MATERIAL FOR LITHIUM ION BATTERY SEPARATOR AND PREPARATION METHOD THEREFOR

(71) Applicant: SOUTH CHINA UNIVERSITY OF TECHNOLOGY, Guangzhou, Guangdong (CN)

(72) Inventors: Haihui WANG, Guangzhou (CN); Suqing WANG, Guangzhou (CN); Jian XUE, Guangzhou (CN)

(73) Assignee: SOUTH CHINA UNIVERSITY OF TECHNOLOGY, Guangzhou, Guangdong (CN)

(21) Appl. No.: 17/610,633

(22) PCT Filed: Nov. 6, 2020
(86) PCT No.: PCT/CN2020/127279

§ 371 Date: Nov. 11, 2021

(30) Foreign Application Priority Data
Nov. 8, 2019 (CN) 201911087296.4

(51) Int. Cl. H01M 50/449; H01M 50/443; H01M 50/44; H01M 50/446; H01M 50/431; H01M 50/423; H01M 50/42; H01M 50/429; H01M 50/426; H01M 50/403; H01M 10/0525

(52) U.S. Cl. CPC H01M 50/449; H01M 50/443; H01M 50/44; H01M 50/446; H01M 50/431; H01M 10/0525; H01M 50/42; H01M 50/4295; H01M 50/426; H01M 50/403; H01M 50/423

(57) ABSTRACT

Provided are a functional coating material for a lithium ion battery separator and a preparation method therefor. The functional coating material for a lithium ion battery separator comprises 1-15% mass fraction of inorganic nanoparticles, 8-30% mass fraction of nanofibers and 1-5% mass fraction of an adhesive, and the remainder being a solvent. The preparation method therefor comprises the following steps: (1) preparing the nanofibers as a spinning precursor liquid; (2) preparing a dispersion liquid with the inorganic nanoparticles and the spinning precursor liquid; and (3) adding the adhesive to the dispersion liquid, and mixing same until uniform to obtain the functional coating material for a lithium ion battery separator.

The present application claims the priority of Chinese patent application No. 201911087296.4, filed on Nov. 8, 2019, titled “a functional coating material for lithium ion battery separator and a method for preparing the same”, the contents of which is incorporated herein by reference in its entirety.

### TECHNICAL FIELD

The present disclosure belongs to the technical field of battery separator coating, and particularly relates to a functional coating material for lithium ion battery separator and a method for preparing the same.

### BACKGROUND

In recent years, lithium battery industry has developed rapidly with the rapid development of electric vehicles and portable electronic products and the use of large-scale lithium ion green power batteries. The appearance and size of batteries have changed due to the expansion of the application fields and the increase in demand, and lithium secondary batteries are required to have better durability and safety than existing small batteries.

Considering the safety of lithium batteries, more and more battery companies have begun to focus on the field of separator coating modification to produce composite lithium ion battery separators. Existing coated separators are mainly coated with polypropylene (PP), polyethylene (PE) and non-woven fabrics. The commonly used separator modification layers are made of inorganic particles, such as boehmite, Al₂O₃, and the like. These inorganic particles have a size generally greater than 500 nm, and the coating layer has a thickness above 2 μm and a density above 3 g/m². Although this improves the battery performance, the volume and mass energy density of the battery can be affected. A thick separator coating layer would also partially hinder the transmission of lithium ions. If the inorganic particles of the coating layer have a small size, they are easy to accumulate and agglomerate, which is difficult to obtain a coating layer with uniform stability.

Patent application CN109321127A discloses an aramid composition for coating lithium battery separators and a method for preparing the same, the composition mainly comprising: an aramid fiber, a binding agent, an solvent, and an emulsifier. The binding agent is used in an amount of 2% to 10% of the mass of the aramid fibere. The binding agent is used in an amount of 4% to 30% of the mass of the solvent. The binding agent is used in an amount of 2% to 10% of the mass of the emulsifier. The aramid fiber is at least one of para-aramid and meta-aramid. The binding agent is at least one of polyvinylidene fluoride (PVDF) or polytetrafluoroethylene (PTFE). The solvent is at least one of N-methylpyrrolidone (NMP), N,N-dimethylacetamide (DMAC) or acetone. The emulsifier is at least one of sodium polyacrylate or polyacrylate. That disclosure provides a new aramid composition for coating lithium battery separators. The composition which is used for coating the separators has advantages of reducing costs and enhancing air permeability, but still requires the use of low-melting emulsifiers, limiting the high temperature resistance of the coating layer.

Patent application CN201410061996.7 discloses a composite nanofiber lithium battery separator and a method for preparing the same, wherein the composite nanofiber lithium battery separator is composed of at least one layer of meta-aramid nanofiber membrane containing nanoparticles and at least one layer of low melting point polymer nanofiber membrane containing nanoparticles. The nanofibers in the fiber membranes containing nanoparticles are interlaced with each other and are bonded and interconnected at the interlaced points. The composite nanofiber lithium battery separator has a fiber surface layer with a pore size ranging from 100 nm to 400 nm, and has a pore-closing temperature ranging from 130° C. to 170° C. The fiber membrane does not shrink after pores are closed A heat shrinkage rate is less than 2% after being heated at a high temperature of 250° C. for 1 hour. Tensile strength is 100 MPa to 1000 MPa. Thus, the composite nanofiber lithium battery separator has the performance of thermal closing effect, good thermal dimensional stability, and high strength. However, the current conditions of production using electrospinning to produce polymer fiber separators cannot meet the large-scale market demand for lithium battery separators.

### SUMMARY

An object of the present disclosure to provide a functional coating material for lithium ion battery separator and preparation method thereof, aiming at the shortcomings in the prior art. A small amount of SiO₂, Al₂O₃, TiO₂ particles are combined with nano-cellulose, thereby reducing the thickness of the separator, strengthening the bonding force between the coating layer and the base membrane, increasing the air permeability and thermal stability of the separator, and improving the lithium ion transmission performance.

In order to achieve the above object, the present disclosure adopts technical solutions as follows.

In an aspect, the present disclosure provides a functional coating material for lithium ion battery separator, the functional coating material comprising inorganic nanoparticles in a mass fraction of 1% to 15%, nanofibers in a mass fraction of 8% to 30%, and an adhesive in a mass fraction of 1% to 5%, with the balance being a solvent.

In an embodiment, the inorganic nanoparticles are preferably in a mass fraction of 10%.

In an embodiment, the inorganic nanofibers are preferably in a mass fraction of 25%.

In an embodiment, the adhesive is preferably in a mass fraction of 3%.

In an embodiment, the inorganic nanoparticles are one or more selected from the group consisting of SiO₂, TiO₂, and Al₂O₃, preferably SiO₂ and/or TiO₂, and more preferably SiO₂ particles.

In an embodiment, the inorganic nanoparticles have an average particle size of 5 nm to 50 nm, preferably 20 nm to 30 nm.

In an embodiment, the nanofibers are one or more selected from the group consisting of aramid nanofibers, cellulose acetate nanofibers, and polyimide nanofibers, preferably aramid nanofibers.

In an embodiment, the adhesive is one or more selected from the group consisting of PMMA, CMC, PVDF-HFP, PVDF, polyacrylic acid, and chitosan, preferably one or more selected from the group consisting of PMMA, CMC, and PVDF-HFP, more preferably PVDF-HFP.

In an embodiment, the solvent is one or more selected from the group consisting of ethanol, water, and NMP, preferably ethanol.

In another aspect, the present disclosure provides a method for preparing the functional coating material for lithium ion battery separator as above, comprising:

(1) preparing the nanofibers into a spinning precursor liquid;

(2) preparing a dispersion liquid using the inorganic nanoparticles and the spinning precursor liquid;

(3) adding the adhesive to the dispersion liquid with well mixing to obtain a functional coating material for lithium ion battery separator.

The preparing the dispersion liquid in step (2) is selected from one of:

a. adding the inorganic nanoparticles to the spinning precursor liquid for electrospinning to obtain an inorganic nanoparticle/nanofiber composite membrane; dispersing the inorganic nanoparticle/nanofiber composite membrane in the solvent to obtain a dispersion liquid;

b. electrospinning the spinning precursor liquid to obtain a nanofiber membrane, dispersing the nanofiber membrane in the solvent, adding the inorganic nanoparticles, and performing dispersing again to obtain the dispersion liquid.

In an embodiment, in step (1) or (2), the spinning precursor liquid is one or more selected from the group consisting of a spinning precursor liquid of aramid nanofibers, a spinning precursor liquid of cellulose acetate nanofibers, or a spinning precursor liquid of polyimide nanofibers, preferably the spinning precursor liquid of aramid nanofibers.

In an embodiment, in step (1) or (2), the nanofibers are in a mass fraction of 15% in the spinning precursor liquid.

In an embodiment, the electrospinning in any one of steps a and b is performed under a condition of a voltage of 10 kV to 20 kV, a solvent base rate of 0.2 mL/h to 1 mL/h, and a receiving distance of 12 cm to 18 cm.

In one embodiment, the dispersing in any one of steps a and b is performed in manners including ultrasonic dispersion and mill beating treatment.

In another aspect, the present disclosure provides a method of using the functional coating material for lithium ion battery separator as above, comprising steps of:

coating the functional coating material for lithium ion battery separator as above on a base membrane; and performing drying.

In an embodiment, the coating may be performed in manners including scraper coating, dip coating, spray coating, and spin coating.

In an embodiment, the coating may have a thickness of 0.5 μm to 3 μm.

In an embodiment, the base membrane may include a PP membrane or a PE membrane.

In an embodiment, the drying is performed in a manner that is drying in an oven at 50° C. to 100° C. for 5 hr to 24 hr.

The present disclosure has the following beneficial effects.

By combining a small amount of SiO₂, Al₂O₃, TiO₂ particles with nano-cellulose, the thickness of the separator can be reduced, and the prepared separator has good air permeability, high thermal stability, good electrolyte wettability, and improved lithium ion transmission performance.

### DETAILED DESCRIPTION OF THE EMBODIMENTS

In order to make the technical means, features, realized objects and technical effects of the present disclosure easy to understand, the present disclosure will be further illustrated below in conjunction with specific embodiments. However, the following embodiments are only preferred, but not all of, embodiments of the present disclosure. Based on the embodiments in the implementations, other embodiments obtained by those skilled in the art without creative work shall fall within the protection scope of the present disclosure.

The experimental methods in the following examples are conventional methods unless otherwise specified. The materials and reagents used in the following examples can be commercially available unless otherwise specified.

The water in the following examples can be tap water, purified water, distilled water, drinking water, or the like.

In the following examples, SiO₂ and Al₂O₃ particles were purchased from Aladdin (Cat. Nos. S139944 and A299287, respectively), and TiO₂ particles were purchased from Degussa (Cat. No. P25).

In the following examples, ultrasonic dispersion is achieved by using an ultrasonic cell disruptor, but not limited thereto.

In the following examples, the spinning precursor liquid of aramid nanofibers, the spinning precursor liquid of cellulose acetate nanofibers, and the spinning precursor liquid of polyimide nanofibers are prepared as follows:

For preparing the spinning precursor liquid of aramid nanofibers, dimethylacetamide is added to an aramid fiber stock solution followed by stirring at 60° C., obtaining the spinning precursor liquid of aramid which is in a mass fraction of 15%.

For preparing the spinning precursor liquid of cellulose acetate nanofibers, cellulose acetate (secondary cellulose acetate with a degree of esterification of 240 to 260) is dissolved in a mixed solvent of acetone and other solvents, obtaining the spinning precursor liquid of cellulose acetate nanofibers which is in a mass fraction of 15%.

For preparing the spinning precursor liquid of polyimide nanofibers, pyromellitic dianhydride and 4,4-diaminodiphenyl ether (ODA) at a molar ratio of 1:1 are added to the N,N-dimethylformamide solvent followed by vigorous stirring for 12 hr in an ice bath at 0° C., finally obtaining a polyimide acid solution in a mass fraction of 15% as the spinning precursor liquid of polyimide nanofibers.

### Example 1-4

(1) Inorganic nanoparticles were added to a spinning precursor liquid for electrospinning to obtain an inorganic nanoparticle/nanofiber composite membrane, and the composite membrane was cut into small pieces and added to a solvent for dispersing by beating using a sand mill at 5000 rpm for 1 hr, obtaining a dispersion liquid.

(2) An adhesive was added to the dispersion liquid and mixed well to obtain a functional coating material for lithium ion battery separator whose composition is shown in Table 1.

(3) The above functional coating material was coated on a PP membrane in a coating thickness of 2 μm with a scraper.

(4) The coated base membrane was put into an oven and dried at 100° C. for 5 hr.

The inorganic nanoparticles have an average particle size of 20 nm in Examples 1 and 2, and an average particle size of 50 nm in Examples 3 and 4.

TABLE 1
Composition of functional coating materials of Examples 1-4

| | Functional coating materials | | | | | | |
|---|---|---|---|---|---|---|---|
| | Composition of | | | Mass | Types and | Types and | |
| | inorganic | | | fraction of | mass | mass | |
| | nanoparticles | | | inorganic | fraction of | fraction of | Solvent |
| Ex. | SiO₂ | Al₂O₃ | TiO₂ | nanoparticles | nanofibers | adhesive | type |
| 1 | 100% | — | — | 1% | Aramid | PMMA | Ethanol |
| | | | | | nanofiber | 1% | |
| | | | | | 8% | | |
| 2 | 50% | 50% | — | 10% | Cellulose | CMC | Water |
| | | | | | acetate | 3% | |
| | | | | | nanofiber | | |
| | | | | | 25% | | |
| 3 | 100% | — | — | 10% | Aramid | PVDF- | NMP |
| | | | | | nanofiber | HFP | |
| | | | | | 25% | 3% | |
| 4 | 50% | — | 50%- | 15% | Cellulose | PVDF | Ethanol |
| | | | | | acetate | 5% | |
| | | | | | nanofiber | | |
| | | | | | 30% | | |

### Example 5-10

(1) The nanofiber membrane obtained by electrospinning the spinning precursor liquid was cut into small pieces and added to a solvent for well dispersing using an ultrasonic cell disruptor, and then the inorganic nanoparticles were added for another ultrasonic dispersing, obtaining a dispersion liquid.

(2) An adhesive was added to the dispersion liquid and mixed well to obtain a functional coating material for lithium ion battery separator whose composition is shown in Table 2.

(3) The above functional coating material was sprayed on a PE membrane in a coating thickness of 1.5 μm.

(4) The coated base membrane was put into an oven and dried at 50° C. for 24 hr.

The inorganic nanoparticles have an average particle size of 5 nm in Examples 5 and 6, and an average particle size of 30 nm in Examples 7-10.

TABLE 2
Composition of functional coating materials of Examples 5-10

| | Functional coating materials | | | | | | |
|---|---|---|---|---|---|---|---|
| | Composition of | | | Mass | Types and | Types and | |
| | inorganic | | | fraction of | mass | mass | |
| | nanoparticles | | | inorganic | fraction of | fraction of | Solvent |
| Ex. | SiO₂ | Al₂O₃ | TiO₂ | nanoparticles | nanofibers | adhesive | type |
| 5 | 100% | — | — | 1% | Aramid | PMMA | Ethanol |
| | | | | | nanofiber | 1% | |
| | | | | | 8% | | |
| 6 | 50% | 50% | — | 10% | Cellulose | chitosan | Water |
| | | | | | acetate | 3% | |
| | | | | | nanofiber | | |
| | | | | | 25% | | |
| 7 | 100% | — | — | 10% | Aramid | PVDF- | NMP |
| | | | | | nanofiber | HFP | |
| | | | | | 25% | 3% | |
| 8 | 50% | — | 50%- | 15% | Cellulose | PVDF | Ethanol |
| | | | | | acetate | 5% | |
| | | | | | nanofiber | | |
| | | | | | 30% | | |
| 9 | 100% | | — | 10% | Aramid | Poly- | Water |
| | | | | | nanofiber | acrylic | |
| | | | | | 20% | acid | |
| | | | | | | 5% | |
| 10 | 100% | — | — | 15% | Polyimide | PVDF- | NMP |
| | | | | | nanofiber | HFP | |
| | | | | | 25% | 3% | |

### Comparative Example 1

(1) The nanofiber membrane obtained by electrospinning was cut into small pieces and added to a solvent for well dispersing using an ultrasonic cell disruptor, obtaining a dispersion liquid.

(2) An adhesive was added to the dispersion liquid and mixed well to obtain a functional coating material for lithium ion battery separator whose composition is shown in Table 3.

(3) The above functional coating material was sprayed on a PE membrane in a coating thickness of 1.5 μm.

(4) The coated base membrane was put into an oven and dried at 50° C. for 24 hr.

### Comparative Example 2 and 3

(1) The nanofiber membrane obtained by electrospinning was cut into small pieces and added to a solvent for well dispersing using an ultrasonic cell disruptor, obtaining a dispersion liquid. Then, the inorganic nanoparticles were added for another ultrasonic dispersing, obtaining a dispersion liquid.

(2) An adhesive was added to the dispersion liquid and mixed well to obtain a functional coating material for lithium ion battery separator whose composition is shown in Table 3.

(3) The above functional coating material was sprayed on a PE membrane in a coating thickness of 1.5 μm.

(4) The coated base membrane was put into an oven and dried at 50° C. for 24 hr.

The inorganic nanoparticles have an average particle diameter of 30 nm.

TABLE 3
Composition of functional coating materials of Comparative
Examples 1-3

| | Functional coating materials | | | | | | |
|---|---|---|---|---|---|---|---|
| | | | | Mass | Types | Types | |
| | | | | fraction | and | and | |
| | Composition of | | | of | mass | mass | |
| | inorganic | | | inorganic | fraction | fraction | |
| Comp. | nanoparticles | | | nano- | of nano- | of | Solvent |
| Ex. | SiO₂ | Al₂O₃ | TiO₂ | particles | fibers | adhesive | type |
| 1 | — | — | — | — | Aramid | PVDF- | NMP |
| | | | | | nanofiber | HFP | |
| | | | | | 25% | 3% | |
| 2 | 100% | | — | 10% | Aramid | PMMA | Ethanol |
| | | | | | nanofiber | | |
| | | | | | 40% | 3% | |
| 3 | 100% | — | — | 10% | Aramid | PVDF- | |
| | | | | | nanofiber | HFP | |
| | | | | | 5% | 3% | NMP |

Effect Measurement

Thermal stability (150° C., 1 hr), ionic conductivity, air permeability, and wettability (contact angle) of the coated separators prepared in the above examples were measured. The measurement results are shown in Table 4:

TABLE 4
Measurement results of Examples 1-10 and
Comparative Examples 1-3

| | Membrane | | Air permeability | |
|---|---|---|---|---|
| | shrinkage | Ionic | (s/sq.in · | Wettability |
| | (150°C., | conductivity | 100 mL · | (contact |
| | 1 hr) | (mS/cm) | 1.22 kpa) | angle °) |
| Example 1 | 10% | 0.35 | 285 | 40 |
| Example 2 | 5% | 0.56 | 295 | 30 |
| Example 3 | 0.5% | 0.55 | 298 | 30 |
| Example 4 | 0.3% | 0.4 | 302 | 20 |
| Example 5 | 12% | 0.38 | 270 | 42 |
| Example 6 | 6% | 0.59 | 280 | 29 |
| Example 7 | 0.8% | 0.57 | 285 | 28 |
| Example 8 | 0.5% | 0.42 | 295 | 21 |
| Example 9 | 0.3% | 0.45 | 285 | 25 |
| Example 10 | 0.8% | 0.43 | 290 | 27 |
| Comparative | 5% | 0.32 | 280 | 35 |
| Example 1 | | | | |
| Comparative | 0.5% | 0.35 | 360 | 25 |
| Example 2 | | | | |
| Comparative | 15% | 0.42 | 270 | 30 |
| Example 3 | | | | |

The measurement results show that the separators coated with the functional coating material for lithium ion battery separator that is made of the inorganic nanoparticles and the nanofibers had significantly improved thermal stability, ionic conductivity, and wettability, and the air permeability thereof was not affected. In Examples 3 and 4, the membrane shrinkage at 150° C. for 1 hr decreased to 0.5% and 0.3%, and the thermal stability was better than that of Comparative Example 1 without the addition of inorganic nanoparticles. Comparative Examples 2 and 3 show that the aramid nanofiber, when used too much, would affect the dispersibility of the fiber and the wettability and air permeability of the membrane. On the contrary, the aramid nanofiber, when used too little, was not beneficial to thermal stability.

The functional coating material for separator in the present disclosure reduces the thickness of the separator while retaining inorganic nanoparticles. Through the hydrogen bond force between the fiber and the separator, the bonding force between the coating layer and the base membrane is strengthened. The thermal stability of the separator is improved. The wettability between the separator and the electrolyte is strengthened. The lithium ion transmission performance is improved. It has a good application prospect.

The above descriptions are only the preferred embodiments of the present disclosure and are not intended to limit the present disclosure. Any modification, equivalent replacement, improvement, and the like made within the spirit and principle of the present disclosure shall be included in the protection scope of the present disclosure.

What is claimed is:

1. A functional coating material for lithium ion battery separator, the functional coating material comprising inorganic nanoparticles in a mass fraction of 1% to 15%, nanofibers in a mass fraction of 8% to 30%, and an adhesive in a mass fraction of 1% to 5%, with the balance being a solvent.

2. The functional coating material for lithium ion battery separator according to claim 1, wherein the inorganic nanoparticles have an average particle size of 5 nm to 50 nm.

3. The functional coating material for lithium ion battery separator according to claim 1, wherein the inorganic nanoparticles have an average particle size of 20 nm to 30 nm.

4. The functional coating material for lithium ion battery separator according to claim 1, wherein the inorganic nanoparticles are one or more selected from the group consisting of SiO₂, TiO₂, and Al₂O₃.

5. The functional coating material for lithium ion battery separator according to claim 1, wherein the inorganic nanoparticles are SiO₂ and/or TiO₂.

6. The functional coating material for lithium ion battery separator according to claim 1, wherein the nanofibers are one or more selected from the group consisting of aramid nanofibers, cellulose acetate nanofibers, and polyimide nanofibers.

7. The functional coating material for lithium ion battery separator according to claim 1, wherein the adhesive is one or more selected from the group consisting of polymethyl methacrylate (PMMA), carboxymethyl cellulose (CMC), polyvinylidene fluoride-hexafluoropropylene (PVDF-HFP), polyvinylidene fluoride (PVDF), polyacrylic acid, and chitosan.

8. The functional coating material for lithium ion battery separator according to claim 1, wherein the solvent is one or more selected from the group consisting of ethanol, water, and N-methylpyrrolidone (NMP).

9. A method for preparing the functional coating material for lithium ion battery separator according to claim 1, comprising step of:
(1) preparing the nanofibers into a spinning precursor liquid;
(2) preparing a dispersion liquid using the inorganic nanoparticles and the spinning precursor liquid;
(3) adding the adhesive to the dispersion liquid with well mixing to obtain a functional coating material for lithium ion battery separator,
wherein the preparing the dispersion liquid in step (2) is selected from one of:
a. adding the inorganic nanoparticles to the spinning precursor liquid for electrospinning to obtain an inorganic nanoparticle/nanofiber composite membrane; dispersing the inorganic nanoparticle/nanofiber composite membrane in the solvent to obtain a dispersion liquid; or
b. electrospinning the spinning precursor liquid to obtain a nanofiber membrane, dispersing the nanofiber membrane in the solvent, adding the inorganic nanoparticles, and performing dispersing again to obtain the dispersion liquid.

10. The method according to claim 9, wherein in step (1) or (2), the spinning precursor liquid is one or more selected from the group consisting of a spinning precursor liquid of aramid nanofibers, a spinning precursor liquid of cellulose acetate nanofibers, or a spinning precursor liquid of polyimide nanofibers.

11. The method according to claim 9, wherein in step (1) or (2), the nanofibers are in a mass fraction of 15% in the spinning precursor liquid.

12. The method according to claim 9, wherein the electrospinning is performed under a condition of a voltage of 10 kV to 20 kV, a solvent base rate of 0.2 mL/h to 1 mL/h, and a receiving distance of 12 cm to 18 cm.

13. The method according to claim 9, wherein the dispersing in any one of steps a and b is performed in manners including ultrasonic dispersion and mill beating treatment.

14. A lithium ion battery separator coated with the functional coating material according to claim 1.

15. The lithium ion battery separator according to claim 14, wherein the functional coating material is coated in a thickness of 0.5 to 3 μm.
